(19) United States
(12) Patent Application Publication
(10) Pub. No.: US 2018/0321668 A1
(43) Pub. Date: Nov. 8, 2018

(54) METHOD FOR DETERMINING DIAGNOSTIC PATTERNS FOR TIME SERIES OF A TECHNICAL SYSTEM, AND DIAGNOSTIC METHOD

(71) Applicant: SIEMENS AKTIENGESELLSCHAFT, München (DE)

(72) Inventors: Stephan GRIMM, München (DE); Stephan GUENNEMANN, München (DE)

(21) Appl. No.: 15/764,023

(22) PCT Filed: Sep. 23, 2016
(86) PCT No.: PCT/EP2016/072731

§ 371 Date: Mar. 28, 2018

(30) Foreign Application Priority Data
Sep. 30, 2015 (EP) 15187594.5

(51) Int. Cl. G05B 23/02

(52) U.S. Cl. CPC G05B 23/0221; G05B 23/0248

(57) ABSTRACT

The disclosure relates to a method for determining diagnostic models for time series of a technical system and to a diagnostic method. In the method for determining one or more diagnostic model/s for time series of a technical system for the purpose of diagnosing an event, firstly, one or more diagnostic models are formulated and, in a first act, possible extensions of the diagnostic model/s are determined; in a second act, for each extension of the/each diagnostic model/s, a set of sequences is determined from the time series, in which the extension is contained; in a third act, each sequence of said set is tested to determine whether the sequence is connected with the event; and in a fourth act, the/those extensions for which the ratio of the number of sequences of the set which are connected with the event to the number of sequences of the set is largest, is/are set as the new diagnostic model.

The present patent document is a § 371 nationalization of PCT Application Ser. No. PCT/EP2016/072731, filed Sep. 23, 2016, designating the United States, which is hereby incorporated by reference, and this patent document also claims the benefit of EP 15187594.5, filed Sep. 30, 2015, which is also hereby incorporated by reference.

### TECHNICAL FIELD

The disclosure relates to a method for determining diagnosis patterns for time series of a technical system and to a diagnosis method.

### BACKGROUND

During the operation of complex technical systems, (e.g., automated production systems or trains), numerous sensors frequently deliver large sets of time series that are available for automated data analysis. Such time series may take the form of sequences of tuples that, by way of example, are provided with a timestamp and contain sensor measurements, factory protocols, or diagnosis reports, for example.

The individual elements of the time series are therefore tuples because multiple properties may convene at one time in the time series. By way of example, multiple events occurring at the same time may form a tuple.

The problem that regularly arises is that of finding particular diagnosis patterns in such time series. In particular, diagnosis patterns whose occurrences indicate particular, (e.g., instantaneous), properties of the technical system are frequently desirable. Such properties may be formed by the failure of a system component, for example. A data analysis may be useful in such cases to detect or predict failures early on.

### SUMMARY AND DESCRIPTION

The scope of the present disclosure is defined solely by the appended claims and is not affected to any degree by the statements within this summary. The present embodiments may obviate one or more of the drawbacks or limitations in the related art.

It is an object of the disclosure to provide a method for determining diagnosis patterns for time series that is able to be used to easily detect one or more properties of the technical system.

Further, it is an object of the disclosure to provide a diagnosis method for diagnosing properties of the technical system.

The method for determining one or more diagnosis pattern(s) for time series of a technical system for the purpose of diagnosis of an event involves one or more diagnosis patterns being formulated. The method includes, in a first act, determining possible extensions of the diagnosis pattern(s); in a second act, determining a set of sequences that contain the extension from the time series for each extension of the diagnosis pattern or each of the diagnosis patterns; in a third act, performing a check for multiple sequences in this set, (e.g., for each sequence in this set), to determine whether or not the sequence is connected to the event; and, in a fourth act, formulating the extension(s) for which the ratio of the number of sequences in the set that are connected to the event and the number of sequences in the set is greatest as (a) new diagnosis pattern(s).

In this way, sequences that have already been regarded as relevant to a certain extent beforehand are used. Accordingly, refined diagnosis patterns are used to selectively search a search space that appears highly promising from the outset at any rate.

In certain methods, instead of the fourth act as described above, in an alternative act, extension(s) for which a different measure of diagnosis quality than the ratio of the number of sequences in the set that are connected to the event and the number of sequences in the set is greatest is/are formulated as (a) new diagnosis pattern(s). Such a measure of diagnosis quality is expediently the ratio of the number of sequences in the set that are connected to the event and the number of sequences in the set, wherein the ratio is additionally provided with a correction factor that is all the smaller the greater the overlap between the set and one or more other sets of further extensions.

Expediently, the measure of diagnosis quality is all the greater the more accurate the diagnosis pattern is for the event. The measure of diagnosis quality may be all the greater the more sequences the set contains that are connected to the event.

In a further development, a different measure of diagnosis quality of this kind is provided by the ratio of the number of sequences in the set that are connected to the event to the number of sequences that are connected to the event (and do not necessarily come from the set), e.g., minus the ratio of sequences in the set that are not connected to the event to the number of sequences that are not connected to the event (and do not necessarily come from the set). In a development of the method, the first, second, third, and fourth acts are repeated once or multiple times. Thus, an ever more sophisticated diagnosis pattern or a set of diagnosis patterns is iteratively obtained.

The method may involve the one or more time series, the diagnosis pattern(s) and the sequence or sequences being successions of elements in the form of tuples. This development takes account of the circumstance that time series may indicate the temporal occurrence of events. Thus, multiple events may occur at the same time, for example, which is suitably mapped by a tuple.

Expediently, a diagnosis pattern is extended, (e.g., an extension of the diagnosis pattern is determined), by virtue of a final element being appended, or a further entry being added to a final tuple. This type of diagnosis pattern generation by extension of the diagnosis pattern is complete and easily accountable.

Suitably, the method involves a diagnosis pattern being contained in a sequence if the successive tuples of the diagnosis pattern are at least parts of tuples of the sequence in the correct relative succession to one another, wherein a maximum interval between successive tuples of the diagnosis pattern is not exceeded within the sequence. This type of “matching” will be explained in more detail using an example:

A diagnosis pattern

P=({a}−>{b, c}) is contained in the sequence

S₁=({c}−>{a, b}−>{b, c}) (with maximum interval “0”) and in the sequence

S₃=({a, e}−>{d}−>{e}−>{b, c, d}) (with maximum interval “2”), but not in the sequence

S₂=({b}−>{a, b}−>{c}).

In a development of the method, a diagnosis pattern is contained in a sequence if successive tuples of the diagnosis pattern are at least parts of tuples of the sequence in the correct relative succession, wherein a respective maximum interval between respective successive tuples of the diagnosis pattern in the succession is not exceeded within the sequence.

That is to say that a maximum interval that cannot be exceeded within the sequence is prescribed between respective successive tuples of the diagnosis pattern beforehand.

The maximum interval may therefore change within the diagnosis pattern. Expediently, the maximum interval is added after each of the arrows as a superscript number in the above depiction of the diagnosis pattern.

The method may involve the entry for a tuple of the diagnosis pattern having an equivalent generic term for this entry. In this way, a diagnosis pattern having generic terms may be used in order to cover a plurality of specific diagnosis patterns.

Expediently, an entry in the tuple of a diagnosis pattern “brake” in a sequence includes the elements “hydraulic brake” or “mechanical brake”, for example, so that the entry “brake” turns up in the sequence again by virtue of the entry “brake” matching the elements “hydraulic brake” or “mechanical brake”.

Expediently, the method involves the extensions of the diagnosis pattern(s) being developed in a tree-like structure, wherein the tree is searched according to a breadth-first search. In this way, the established beam-search method may be used. In accordance with this method, at each level in the tree-like structure, the search space within the possible diagnosis patterns is concentrated on the respective area that appears of interest by the fourth act of the method, as described above.

The diagnosis method involves one or more diagnosis pattern(s) being determined according to a method as claimed in one of the preceding claims, wherein this (these) one or more diagnosis pattern(s) is or are used to detect a diagnosis of properties of the technical system.

### BRIEF DESCRIPTION OF THE DRAWINGS

The disclosure is explained in more detail below using exemplary embodiments that are depicted in the drawings, in which:

FIG. 1 schematically depicts an example of a pseudo code for an algorithm for carrying out the method.

FIG. 2 depicts an example of a schematic block diagram of an event chain having sequences and diagnosis patterns for the performance of the method.

### DETAILED DESCRIPTION

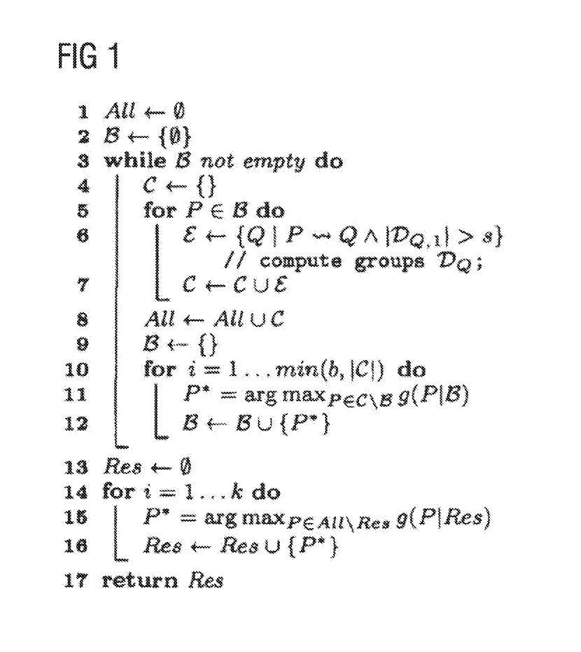

As input variables, the pseudo code depicted in FIG. 1 uses a set of input sequences, a marking function 1, the number of diagnosis patterns k, and the minimum size s of a sequence. The output variable obtained is a set of diagnosis patterns. The depicted algorithm may be used, by way of example, to generate a diagnosis pattern by which it is possible for train breakdowns to be detected or even predicted early on.

The generated diagnosis patterns are logged in line 1. Subsequently, an empty diagnosis pattern is used to start (line 2). The subsequent While loop generates candidates for the next “beam” (of the “beam search” method). For each candidate in the “beam”, the diagnosis pattern is extended by the For loop and the monotony is used. The second For loop is used to construct the next beam.

The algorithm delivers the k best diagnosis patterns as an output value as the result.

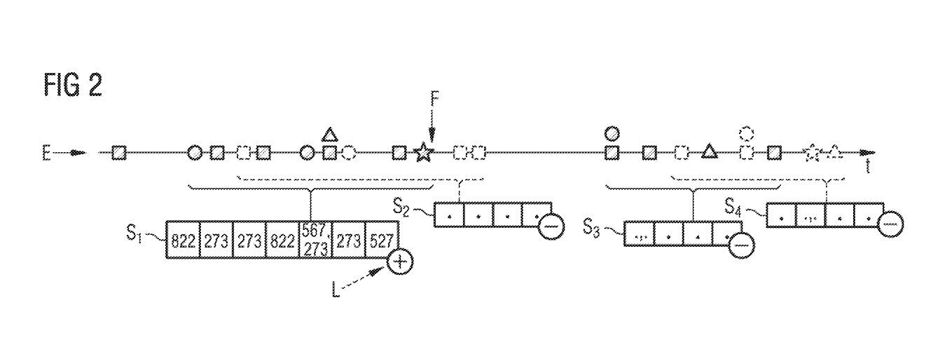

The sequences and diagnosis patterns are depicted in more detail in FIG. 2 by way of example.

According to FIG. 2, train data are analyzed for event diagnosis. To this end, train data about the state of onboard technical equipment are captured during train operation. Each event includes multiple pieces of information. These include a “message code”, which denotes an event type, for example, a “brake lever fault” (that is to say a fault in the operation of the brake lever) or an “emergency brake valve defect” (that is to say a defect in the operation of the emergency brake valve) of a train, and also a train identification number denoting the respective train, the odometer reading of the train, GPS coordinates of the train, and the temperature information from the relevant train. In further exemplary embodiments that are not depicted separately, further data may crop up or parts of the data, (e.g., the temperature information), may be dispensed with.

The train data are denoted in FIG. 2 by the event chain E, which includes the data, which have been captured over several years, for more than 200 trains so that train data in an order of magnitude of approximately 10 million single events are contained in the event chain E. The event chain E is mapped in the upper time line of FIG. 2. Each individual event in the event chain includes the multiple pieces of information as described above regarding the respective event of the train data. The respective events of the event chain E are denoted by basic geometric shapes:

In the depiction shown in FIG. 2, squares mean “brake lever faults” (corresponding numerical code: “273”), circles represent “exterior door fault” (corresponding numerical code: “822”), triangles denote “emergency brake valve defect” (corresponding numerical code: “567”), and stars mean “brake pressure control fault” (corresponding numerical code: “527”).

In FIG. 2, a vertical succession of basic geometric shapes indicates that the corresponding events occur at the same time t (as is customary with time lines, the respective position along the horizontal direction denotes the time t at which the event occurs: the further right an event is positioned, the later it occurs in time).

Expressed in numerical codes, a part of the event chain E for which all events are associated with a single journey by a particular train may be expressed as a sequence S₁={822}→{273}→{273}→{822}→{567, 273}→{273}→{527} (the association between the sequence S₁ and the events of the event chain E is denoted by curly brackets). These events associated with a single journey by a train are denoted in FIG. 2 by solid basic shapes. Other sequences S₂, S₃, S₄ are associated with other journeys and/or other trains (e.g., non-solid basic shapes and/or basic shapes at horizontal intervals from the sequence S₁) in this case.

In a further method act, sequences related to a train breakdown F are preclassified by a binary denotation (namely the label L, which may assume the values “+” or “−”): in the depiction shown in FIG. 2, only the sequence S₁ is related to a train breakdown F, e.g., only the sequence S₁ precedes a train breakdown F for the train with which the events of the sequence S₁ are associated. The label L is depicted as a circle having the value “+” or “−” each time in FIG. 2, the circle being appended to the bottom right of the sequence S₁, S₂, S₃ and S₄ each time.

This sequence S₁ is now used for performing an example of the method.

The diagnosis patterns P₁ are matched to the sequence during performance of the method: the diagnosis pattern P₁={273}→¹ {567}→²{527} fits the sequence S₁.

The method may also involve subsumption hierarchies being taken into consideration. It is thus possible for the numerical code to have terms for components of the train, (e.g., “brake” or “door”), added as above. Further, types of impairment may be taken into consideration as a subsumption hierarchy, for example, as “defect” or “fault” terms. By way of example, the subsumption hierarchy then has the following appearance: the term “defect” subsumes the numerical code “567” (e.g., “emergency brake valve defect”), the term “fault” subsumes the numerical codes “273” (e.g., “brake lever fault”), “527” (e.g., “brake pressure control fault”), and “822” (e.g., “exterior door fault”). The term “brake” subsumes the numerical codes “567” (e.g., “emergency brake valve defect”), “273” (e.g., “brake lever fault”), and “527” (e.g., “brake pressure control fault”). The term “door” subsumes the numerical code “822” (e.g., “exterior door fault”). Consequently, the diagnosis pattern may contain the term “brake”: P₁={Brake}→¹{567}→²{527} now likewise fits the sequence Si, because the term “Brake” subsumes the numerical code “273”.

This external domain knowledge may be used to find diagnosis patterns having a high forecast capability.

Although the disclosure has been illustrated and described in detail by the exemplary embodiments, the disclosure is not restricted by the disclosed examples and the person skilled in the art may derive other variations from this without departing from the scope of protection of the disclosure. It is therefore intended that the foregoing description be regarded as illustrative rather than limiting, and that it be understood that all equivalents and/or combinations of embodiments are intended to be included in this description.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

1. A method for determining one or more diagnosis patterns for time series of a technical system for the purpose of diagnosis of an event, wherein at least one diagnosis patter is formulated, the method comprising:
determining at least one extension of the at least one diagnosis pattern;
identifying a set of sequences that contains the at least one extension from the time series for each extension of each diagnosis pattern;
performing a respective check for multiple sequences in the set of sequences or performing a check for each sequence in the set of sequences to determine whether or not a sequence is connected to the event; and
formulating at least one new diagnosis pattern for which a ratio of a number of sequences in the set of sequences that are connected to the event and an overall number of sequences in the set of sequences is greatest.

2. (canceled)

3. The method of claim 1, further comprising:
repeating the determining, the identifying, the performing , ad the formulating one or more times.

4. The method of claim 1, wherein at least one sequence in the set of sequences and the time series and/or the at least one diagnosis patterns are successions of elements in a form of tuples.

5. The method as claimed in one of the preceding claims, in of claim 1, wherein a diagnosis pattern of the at least one diagnosis pattern is contained in a sequence in the set of sequences when successive tuples of the diagnosis pattern are at least parts of tuples of the sequence in a correct relative succession, wherein a maximum interval between the successive tuples of the diagnosis pattern is not exceeded within the sequence.

6. The method of claim 1, wherein a diagnosis pattern of the at least one diagnosis pattern is contained in a sequence in the set of sequences when successive tuples of the diagnosis pattern are at least parts of tuples of the sequence in a correct relative succession, wherein a respective maximum interval between respective successive tuples of the diagnosis pattern is not exceeded within the sequence.

7. The method of claim 1, wherien an entry for a tuple of the diagnosis pattern has an equivalent generic term for this entry.

8. The method of claim 1, wherein the extensions of the at least one diagnosis pattern are developed in a tree structure, wherein the tree structure is searched according to a breadth-first search.

9. The method of claim 1, wherein an extension of the at least one diagnosis pattern is determined by virtue of a final element being appended, or a further entry being added to a final tuple.

10. A diagnosis method for a technical system, the method comprising:
determining at least one extension of at least one diagnosis pattern;
identifying a set of sequences that contains the at least one extension from a time series for each extension of each diagnosis pattern;
performing a respective check for multiple sequences in the set of sequences or performing a check for each sequence in the set of sequences to determine whether or not a sequence is connected to the event
formulating at least one new diagnosis pattern for which a ratio of a number of sequences in the set of sequences that are connected to the event and an overall number of sequences in the set of sequences is greatest; and
detect a diagnosis of a property of the technical system using the at least one new diagnosis pattern.

11. The method of claim 4, wherein a diagnosis pattern of the at least one diagnosis pattern is contained in a sequence in the set of sequences when successive tuples of the diagnosis pattern are at least parts of tuples of the sequence in a correct relative succession, wherein a maximum interval between the successive tuples of the diagnosis pattern is not exceeded within the sequence.

12. The method of claim 4, wherein a diagnosis pattern of the at least one diagnosis pattern is contained in a sequence in the set of sequences when successive tuples of the diagnosis pattern are at least parts of tuples of the sequence in a correct relative succession, wherein a respective maximum interval between respective successive tuples of the diagnosis pattern is not exceeded within the sequence.

13. The method of claim 4, wherein an entry for a tuple of the diagnosis pattern has an equivalent generic term for this entry.

14. The method of claim 4, wherein the extensions of the at least one diagnosis pattern are developed in a tree structure, wherein the tree structure is searched according to a breadth-first search.

15. The method of claim 4, wherein an extension of the at least one diagnosis pattern is determined by virtue of a final element being appended, or a further entry being added to a final tuple.
